(19) United States
(12) Patent Application Publication
(10) Pub. No.: US 2002/0160177 A1
(43) Pub. Date: Oct. 31, 2002

(54) Polycarbonate compositions with improved foam adhesion

(76) Inventors: Holger Warth, Dormagen (DE); Matthias Voetz, Koln (DE); Dirk Wegener, Monheim (DE)

Correspondence Address: BAYER CORPORATION, PATENT DEPARTMENT, 100 BAYER ROAD, PITTSBURGH, PA, 15205, US

(21) Appl. No.: 10/080,300

(22) Filed: Feb. 21, 2002

(30) Foreign Application Priority Data
Feb. 26, 2001 (DE) 10109226.1

(51) Int. Cl. B32B 7/12; B32B 9/00; B32B 27/00; B32B 27/36; B32B 27/40; D01D 5/12

(52) U.S. Cl. 428/318.4; 428/319.3; 428/319.7; 428/412; 428/423.1; 428/424.6; 428/423.3; 264/210.1

(57) ABSTRACT

A polycarbonate composition featuring improved adhesion to polyurethane, preferably polyurethane foam is disclosed. The composition contains (A) an aromatic polycarbonate and/or polyester-carbonate, (B) a graft polymer and (C) a copolymer of styrene and a monomer containing carboxyl groups, the copolymer having a weight average molecular weight M_{w} of >10,500 g/mol. Composite materials containing layers of the inventive composition and polyurethane layer, preferably foam, are also disclosed.

### FIELD OF THE INVENTION

The invention relates to polycarbonate compositions with improved foam adhesion and composite materials produced therefrom. Summary of the Invention A polycarbonate composition featuring improved adhesion to polyurethane, preferably polyurethane foam is disclosed. The composition contains (A) an aromatic polycarbonate and/or polyester-carbonate, (B) a graft polymer and (C) a copolymer of styrene and a monomer containing carboxyl groups, the copolymer having a weight average molecular weight M_{w} of >10,500 g/mol. Composite materials containing layers of the inventive composition and polyurethane layer, preferably foam, are also disclosed.

### BACKGROUND OF THE INVENTION

It is known that composites of a thermoplastic material and a polyurethane, in particular a polyurethane foam, do not show adequate adhesion of the composite, since in particular unreacted, low molecular weight reaction components as residues from the preparation of the plastics materials segregate in the interfaces of the layers. There has therefore been no lack of attempts to improve the adhesion of composites by using adhesion promoter layers. However, this is not desirable for use in the motor vehicle industry, where such composite materials are being used to an increasing degree, since materials which differ as little as possible should be employed because of the processing and recycling properties required.

DE 199 24 091 A1 discloses a composite material of polyurethane and a thermoplastic, in which, to improve the adhesion, the polyurethane layer comprises homogeneously distributed particles with an median particle size of 1 to 10 nm coated with a thermoplastic.

DE 199 24 092 A1 furthermore discloses a composite material of polyurethane and a thermoplastic material, polyurethane which has a residual content of not more than 400 ppm of free reaction components containing ether groups being employed to improve the adhesion between the polyurethane and thermoplastic layer.

Finally, JP 11-60851 describes a thermoplastic resin composition which comprises (a) 3 to 50 wt. % of a graft polymer, (b) 5 to 90 wt. % of a vinyl copolymer, (c) 0.01 to 5 wt. % of a low molecular weight oligomeric styrene/maleic anhydride copolymer with an average molecular weight M_{w} of 500 to 10,000 and (d) 0.98 wt. % of an aromatic polycarbonate. The polycarbonate compositions described in the examples of this publication have a styrene/maleic anhydride copolymer content of 0.05 to 0.2 wt. %. A polycarbonate composition with a content of styrene/maleic anhydride copolymer of 7 wt. % is furthermore described. The polycarbonate compositions described in this publication have an improved notched impact strength, heat stability and improved processing properties, and are used as housing components for office machines and electrical appliances. The influence of the styrene/maleic anhydride copolymer on the foam adhesion of the polycarbonate composition with respect to polyurethane is not described in this publication.

### DETAILED DESCRIPTION OF THE INVENTION

The invention is based on the object of providing polycarbonate compositions, which have an excellent foam adhesion, in particular with respect to polyurethane foams. The polycarbonate compositions are suitable for the preparation of composite materials with commercially available polyurethane foams, and require no additives to the polyurethane foams to improve the adhesion effect.

In addition to the improved foam adhesion, the polycarbonate compositions have outstanding mechanical properties and excellent processability.

This object is achieved according to the invention by a polycarbonate composition, which comprises

(A) aromatic polycarbonate and/or polyester-carbonate,

(B) graft polymer and

(C) copolymer of styrene and at least one monomer containing at least one carboxyl group, the copolymer having an average molecular weight M_{w} of >10,500 g/mol.

The copolymer may additionally contain one or more other vinyl comonomers.

Surprisingly, it has been found that the addition of a copolymer (C) to impact-modified polycarbonate, a considerable improvement in the foam adhesion, in particular the foam adhesion with respect to polyurethane foams, is achieved. At the same time, the polycarbonate compositions according to the invention have excellent mechanical properties.

According to a preferred embodiment of the invention, the polycarbonate composition contains component (C) in an amount of 0.4 to 7, preferably 1 to 4, particularly preferably 1 to 3 wt. %, in particular 1.5 to 2.5 wt. % relative to the weight of the composition. It has been found, surprisingly, that a particularly great improvement in the foam adhesion, in particular the foam adhesion with respect to polyurethane foams, is achieved in these ranges.

The polycarbonate compositions according to the invention show, in addition to an excellent notched impact strength and an outstanding melt viscosity, a deterioration in adhesion of less than 5% in a composite with polyurethane after carrying out a double alternating climate test over 24 hours with cycles of −40 to 80° C. and 0 to 80% relative atmospheric humidity. Because of their outstanding foam adhesion properties, the polycarbonate molding compositions according to the invention are particularly suitable for the preparation of composite materials with polyurethane foams.

The individual components of the polycarbonate composition according to the invention are explained by way of example in the following.

Component A

Aromatic polycarbonates and/or aromatic polyester-carbonates according to component A which are suitable according to the invention are known from the literature or may be prepared by processes known from the literature (for the preparation of aromatic polycarbonates see, for example, Schnell, “Chemistry and Physics of Polycarbonates”, lnterscience Publishers, 1964 and DE-AS 1 495 626, DE-A 2 232 877, DE-A 2 703 376, DE-A 2 714 544, DE-A 3 000 610 and DE-A 3 832 396; for the preparation of aromatic polyester-carbonates e.g. DE-A 3 077 934).

Aromatic polycarbonates are prepared e.g. by reaction of diphenols with carbonic acid halides, preferably phosgene, and/or with dicarboxylic acid halides, preferably benzenedicarboxylic acid dihalides, by the phase boundary process, optionally using chain terminators, for example monophenols, and optionally using branching agents which are trifunctional or more than trifunctional, for example triphenols or tetraphenols.

Diphenols for the preparation of the aromatic polycarbonates and/or aromatic polyester-carbonates are preferably those of the formula (I)

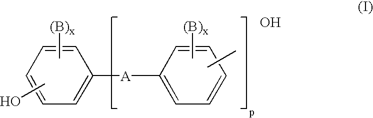

wherein

A denotes a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, on to which further aromatic rings optionally containing heteroatoms may be fused,

or a radical of the formula (II) or (III)

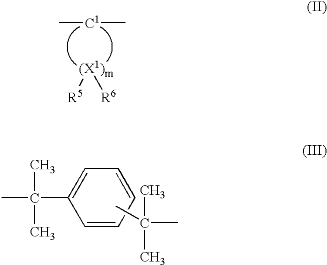

B in each case denotes C₁ to C₁₂-alkyl, preferably methyl, or halogen, preferably chlorine and/or bromine,

x in each case independently of one another, denotes 0, 1 or 2 and

p is 1 or 0, and

R⁵ and R⁶ may be chosen individually for each X¹ and independently of one another denote hydrogen or C₁ to C₆-alkyl, preferably hydrogen, methyl or ethyl,

X¹ denotes carbon and

m denotes an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl) sulfoxides, bis-(hydroxyphenyl) ketones, bis-(hydroxyphenyl) sulfones and α,α-bis-(hydroxyphenyl)-diisopropyl-benzenes and derivatives thereof brominated on the nucleus and/or chlorinated on the nucleus.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl sulfone and di- and tetrabrominated or -chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane.

2,2-Bis-(4-hydroxyphenyl)-propane (bisphenol A) is particularly preferred.

The diphenols may be employed individually or as any desired mixtures.

The diphenols are known from the literature or are obtainable by processes known from the literature.

Suitable chain terminators for the preparation of the thermoplastic aromatic polycarbonates are, for example, phenol, p-chlorophenol, p-tert-butylphenol or 2,4,6-tribromophenol, and also long-chain alkylphenols, such as 4-(1,3-tetramethylbutyl)-phenol according to DE-A 2 842 005 or monoalkylphenols or dialkylphenols having a total of 8 to 20 C atoms in the alkyl substituents, such as 3,5-di-tert-butylphenol, p-iso-octylphenol, p-tert-octylphenol, p-dodecylphenol and 2-(3,5-dimethylheptyl)-phenol and 4-(3,5-dimethylheptyl)-phenol. The amount of chain terminators to be employed is in general between 0.5 mol % and 10 mol %, based on the molar sum of the particular diphenols employed.

The thermoplastic aromatic polycarbonates have average weight-average molecular weights (M_{w}, measured e.g. by ultracentrifuge or scattered light measurement) of 10,000 to 200,000, preferably 15,000 to 80,000.

The thermoplastic aromatic polycarbonates may be branched in a known manner, and in particular preferably by incorporation of 0.05 to 2.0 mol %, based on the sum of diphenols employed, of compounds which are trifunctional or more than trifunctional, for example those with three or more phenolic groups.

Both homopolycarbonates and copolycarbonates are suitable. To prepare copolycarbonates according to the invention according to component A, 1 to 25 wt. %, preferably 2.5 to 25 wt. % (based on the total amount of diphenols to be employed) of polydiorganosiloxanes with hydroxyaryloxy end groups may also be employed. These are known (U.S. Pat. No. 3,419,634) or may be prepared by processes known from the literature. The preparation of copolycarbonates comprising polydiorganosiloxanes is described in DE A 3 334 782.

Preferred polycarbonates are, in addition to the bisphenol A homopolycarbonates, the copolycarbonates of bisphenol A with up to 15 mol %, based on the molar sums of diphenols, of other diphenols mentioned as preferred or particularly preferred, in particular 2,2-bis(3,5-dibromo-4-hydroxyphenyl)-propane.

Aromatic dicarboxylic acid dihalides for the preparation of aromatic polyester-carbonates are preferably the di-acid dichlorides of isophthalic acid, terephthalic acid, diphenyl ether-4,4′-dicarboxylic acid and naphthalene-2,6-dicarboxylic acid.

Mixtures of the di-acid dichlorides of isophthalic acid and terephthalic acid in a ratio of between 1:20 and 20:1 are particularly preferred.

A carbonic acid halide, preferably phosgene, is additionally co-used as a bifunctional acid derivative in the preparation of polyester-carbonates.

Possible chain terminators for the preparation of the aromatic polyester-carbonates are, in addition to the monophenols already mentioned, also chlorocarbonic acid esters thereof and the acid chlorides of aromatic monocarboxylic acids, which may optionally be substituted by C₁-C₂₂-alkyl groups or by halogen atoms, as well as aliphatic C₂-C₂₂-monocarboxylic acid chlorides.

The amount of chain terminators is in each case 0.1 to 10 mol %, based on the moles of diphenol in the case of the phenolic chain terminators and on the moles of dicarboxylic acid dichlorides in the case of monocarboxylic acid chloride chain terminators.

The aromatic polyester-carbonates may also comprise incorporated aromatic hydroxycarboxylic acids.

The aromatic polyester-carbonates may be either linear or branched in a known manner (for this see DE-A 2 940 024 and DE-A 3 007 934).

Branching agents which may be used are, for example, carboxylic acid chlorides which are trifunctional or more than trifunctional, such as trimesic acid trichloride, cyanuric acid trichloride, 3,3′,4,4′-benzophenonetetracarboxylic acid tetrachloride, 1,4,5,8-naphthalenetetracarboxylic acid tetrachloride or pyromellitic acid tetrachloride, in amounts of 0.01 to 1.0 mol %, based on the dicarboxylic acid dichlorides employed, or phenols which are trifunctional or more than trifunctional, such as phloroglucinol, 4,6-dimethyl-2,4,6-tri-(4-hydroxyphenyl)-hept-2-ene, 4,4-dimethyl-2,4,6-tri-(4-hydroxyphenyl)-heptane, 1,3,5-tri-(4-hydroxyphenyl)-benzene, 1,1,1 -tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopropyl]-phenoxy)-methane or 1,4-bis[4,4′-dihydroxytriphenyl)-methyl]-benzene, in amounts of 0.01 to 1.0 mol %, based on the diphenols employed. Phenolic branching agents may be initially introduced into the reaction vessel with the diphenols, and acid chloride branching agents may be introduced together with the acid dichlorides.

The content of carbonate structural units in the thermoplastic aromatic polyester-carbonates may be varied as desired. The content of carbonate groups is preferably up to 100 mol %, in particular up to 80 mol %, particularly preferably up to 50 mol %, based on the sum of ester groups and carbonate groups. Both the ester and the carbonate content of the aromatic polyester-carbonates may be present in the polycondensate in the form of blocks or in random distribution.

The relative solution viscosity (ηᵣₑₗ) of the aromatic polycarbonates and polyester-carbonates is in the range from 1.18 to 1.4, preferably 1.20 to 1.32 (measured on solutions of 0.5 g polycarbonate or polyester-carbonate in 100 ml methylene chloride solution at 25° C.).

The thermoplastic aromatic polycarbonates and polyester-carbonates may be employed by themselves or in any desired mixture.

The composition according to the invention may comprise component A in an amount of preferably 5 to 98 wt. %, particularly preferably 10 to 90 wt. %, and in the most preferred manner 40 to 75 wt. %, based on the weight of the composition.

Component B

Component B comprises one or more graft polymers of

B.1 5 to 95, preferably 30 to 90 wt. % of at least one vinyl monomer on

B.2 95 to 5, preferably 70 to 10 wt. % of one or more graft bases with glass transition temperatures of <10° C., preferably <0° C., particularly preferably <−10° C.

The graft base B.2 in general has median particle size (d₅₀ value) of 0.05 to 10 μm, preferably 0.1 to 5 μm, particularly preferably 0.2 to 1 μm.

Monomers B.1 are preferably mixtures of

B.1.1 50 to 99 parts by wt. of vinylaromatics and/or vinylaromatics substituted on the nucleus (such as, for example, styrene, α-methylstyrene, p-methylstyrene and p-chlorostyrene) and/or methacrylic acid (C₁-C₈)-alkyl esters (such as methyl methacrylate and ethyl methacrylate) and

B.1.2 1 to 50 parts by wt. of vinyl cyanides (unsaturated nitriles, such as acrylonitrile and methacrylonitrile) and/or (meth)acrylic acid (C₁-C₈)-alkyl esters (such as methyl methacrylate, n-butyl acrylate and tert-butyl acrylate) and/or imides of unsaturated carboxylic acids (for example N-phenyl-maleimide).

Preferred monomers B.1.1 are chosen from at least one of the monomers styrene, α-methylstyrene and methyl methacrylate, and preferred monomers B.1.2 are chosen from at least one of the monomers acrylonitrile and methyl methacrylate.

Particularly preferred monomers are B.1.1 styrene and B.1.2 acrylonitrile.

Graft bases B.2 which are suitable for the graft polymers B are, for example, diene rubbers, EP(D)M rubbers, that is to say those based on ethylene/propylene and optionally diene, and acrylate, polyurethane, silicone, chloroprene and ethylene/vinyl acetate rubbers.

Preferred graft bases B.2 are diene rubbers (e.g. based on butadiene, isoprene etc.) or mixtures of diene rubbers or copolymers of diene rubbers or mixtures thereof with further copolymerizable monomers (e.g. according to B.1.1 and B.1.2), with the proviso that the glass transition temperature of component B.2 is below <10° C., preferably <0° C., particularly preferably <−10° C.

Pure polybutadiene rubber and EPDM rubbers are particularly preferred.

Particularly preferred polymers B are e.g. ABS polymers (emulsion, bulk and suspension ABS), such as are described e.g. in DE-A 2 035 390 (=U.S. Pat. No. 3,644,574) or in DE-A 2 248 242 (=GB-P 1 409 275) or in Ullmanns Enzyklopädie der Technischen Chemie [Ullmann's Encyclopaedia of Industrial Chemistry], vol.19 (1980), p.280 et seq.. The gel content of the graft base B.2 is at least 30 wt. %, preferably at least 40 wt. % (measured in toluene).

The graft polymers B are prepared by free-radical polymerization, e.g. by emulsion, suspension, solution or bulk polymers, preferably by emulsion or bulk polymerization.

ABS polymers which are prepared by redox initiation with an initiator system of organic hydroperoxide and ascorbic acid in accordance with U.S. Pat. No. 4,937,285 are also particularly suitable graft rubbers.

Since, as is known, during the grafting reaction the graft monomers are not necessarily grafted completely on to the graft base, according to the invention graft polymers B are also understood as meaning those products which are obtained by (co)polymerization of the graft monomers in the presence of the graft base and are also obtained during the working up.

Suitable acrylate rubbers according to B.2 of the polymers B are, preferably, polymers of acrylic acid alkyl esters, optionally with up to 40 wt. %, based on B.2, of other polymerizable, ethylenically unsaturated monomers. The preferred polymerizable acrylic acid esters include C₁-C₈-alkyl esters, for example the methyl, ethyl, butyl, n-octyl and 2-ethylhexyl esters; halogenoalkyl esters, preferably halogeno-C₁-C₈-alkyl esters, such as chloroethyl acrylate, and mixtures of these monomers.

Monomers with more than one polymerizable double bond may be copolymerized for crosslinking. Preferred examples of crosslinking monomers are esters of unsaturated monocarboxylic acids having 3 to 8 C atoms and unsaturated monohydric alcohols having 3 to 12 C atoms, or saturated polyols having 2 to 4 OH groups and 2 to 20 C atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; and also triallyl phosphate and diallyl phthalate.

Preferred crosslinking monomers are allyl methacrylate, ethylene glycol dimethacrylate, diallyl phthalate and heterocyclic compounds which contain at least three ethylenically unsaturated groups.

Particularly preferred crosslinking monomers are the cyclic monomers triallyl cyanurate, triallyl isocyanurate, triacryloylhexahydro-s-triazine and triallylbenzenes. The amount of crosslinking monomers is preferably 0.02 to 5, in particular 0.05 to 2 wt. %, based on the graft base B.2.

In the case of cyclic crosslinking monomers with at least three ethylenically unsaturated groups, it is advantageous to limit the amount to less than 1 wt. % of graft base B.2.

Preferred “other” polymerizable ethylenically unsaturated monomers which may optionally be used, in addition to the acrylic acid esters, for the preparation of the graft base B.2 are e.g. acrylonitrile, styrene, α-methylstyrene, acrylamides, vinyl C₁-C₆-alkyl ethers, methyl methacrylate and butadiene. Preferred acrylate rubbers as graft base B.2 are emulsion polymers which have a gel content of at least 60 wt. %.

Further suitable graft bases according to B.2 are silicone rubbers with grafting-active sites, such as are described in DE-A 3 704 657, DE-A 3 704 655, DE-A 3 631 540 and DE-A 3 631 539.

The gel content of the graft base B.2 is determined at 25° C. in a suitable solvent (M. Hoffmann, H. Kromer, R. Kuhn, Polymeranalytik I und II, Georg Thieme-Verlag, Stuttgart 1977).

The median particle size d₅₀ is the diameter above and below which in each case 50 wt. % of the particles lie. It may be determined by means of ultracentrifuge measurement (W. Scholtan, H. Lange, Kolloid, Z. und Z. Polymere 250 (1972), 782-796).

The composition according to the invention may comprise component B in an amount of preferably 1 to 94 wt. %, particularly preferably 2 to 80 wt. %, in particular 5 to 60 wt. % and very particularly preferably 10 to 50 wt. %, based on the weight of the composition.

Component C

Component C is a copolymer of styrene and at least one monomer containing at least one carboxyl group, the copolymer having a weight average molecular weight, M_{w}, of ≧10,500. An example of a monomer containing carboxyl groups which may be employed according to the invention is maleic anhydride. Copolymers with a content of 1 to 40, preferably 5 to 25 wt. %, based on the copolymer, of monomers containing carboxyl groups, preferably maleic anhydride, are preferably employed. The copolymers employed as component C preferably have an average molecular weight M_{w} (weight-average, determined by light scattering or sedimentation) of 10,500 to 300,000, in particular 15,000 to 200,000 and most preferably 60,000 to 150,000. The copolymers are preferably resinous, thermoplastic and rubber-free. The copolymer may comprise, as further comonomers, acrylonitrile, C₁-C₆-alkyl acrylates or C₁-C₆-alkyl methacrylates in an amount of up to 40, preferably 0 to 30, in particular 0 to 20 wt. % (based on the copolymer).

The copolymers of component C are known and may be prepared by free-radical polymerization, in particular by emulsion, suspension, solution or bulk polymerization.

Particularly preferred copolymers are random copolymers of styrene and maleic anhydride, which may preferably be prepared from the corresponding monomers by a continuous bulk or solution polymerization by known methods.

The composition according to the invention may comprise component C in an amount of preferably 0.4 to 7 wt. %, in particular 1 to 4 wt. %, based on the weight of the composition. Particularly good results with regard to the foam adhesion with respect to polyurethane foams are achieved if the composition contains component C in an amount of preferably 1 to 3 wt. %, in particular 1.5 to 2.5 wt. %, based on the composition.

Further components, such as thermoplastic polymers and polyesters, may be added to the composition. The compositions according to the invention may preferably comprise thermoplastic vinyl (co)polymers and/or polyalkylene terephthalates (component D).

Component D

Component D comprises one or more thermoplastic vinyl (co)polymers D.1 different from component C and/or polyalkylene terephthalates D.2.

Suitable vinyl (co)polymers D.1 are polymers of at least one monomer from the group consisting of vinylaromatics, vinyl cyanides (unsaturated nitriles), (meth)acrylic acid (C₁ to C₈)-alkyl esters and imide derivatives of unsaturated carboxylic acids. Particularly suitable (co)polymers are those of

D.1.1 50 to 99, preferably 60 to 80 parts by wt. of vinylaromatics and/or vinylaromatics substituted on the nucleus, such as, for example, styrene, α-methylstyrene, p-methylstyrene and p-chlorostyrene, and/or methacrylic acid (C₁ to C₈)-alkyl esters, such as methyl methacrylate and ethyl methacrylate, and

D.1.2 1 to 50, preferably 20 to 40 parts by wt. of vinyl cyanides (unsaturated nitriles), such as acrylonitrile and methacrylonitrile, and/or (meth)acrylic acid (C₁-C₈)-alkyl esters (such as methyl methacrylate, n-butyl acrylate and tert-butyl acrylate).

The (co)polymers D.1 are resinous, thermoplastic and rubber-free.

The copolymer of D.1.1 styrene and D.1.2 acrylonitrile is particularly preferred.

The (co)polymers according to D.1 are known and may be prepared by free-radical polymerization, in particular by emulsion, suspension, solution or bulk polymerization. The (co)polymers preferably have average molecular weights M_{w} (weight-average, determined by light scattering or sedimentation) of between 15,000 and 200,000.

The polyalkylene terephthalates of component D.2 are reaction products of aromatic dicarboxylic acids or their reactive derivatives, such as dimethyl esters or anhydrides, and aliphatic, cycloaliphatic or araliphatic diols, and mixtures of these reaction products.

Preferred polyalkylene terephthalates contain at least 80 mol %, preferably at least 90 mol %, based on the dicarboxylic acid component, of terephthalic acid radicals and at least 80 mol %, preferably at least 90 mol %, based on the diol component, of ethylene glycol radicals and/or butane-1,4-diol radicals.

The preferred polyalkylene terephthalates may contain, in addition to terephthalic acid radicals, up to 20 mol %, preferably up to 10 mol %, of radicals of other aromatic or cycloaliphatic dicarboxylic acids having 8 to 14 C atoms or aliphatic dicarboxylic acids having 4 to 12 C atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid and cyclohexanediacetic acid.

The preferred polyalkylene terephthalates may comprise, in addition to ethylene glycol radicals or butane-1,4-diol radicals, up to 20 mol %, preferably up to 10 mol % of other aliphatic diols having 3 to 12 C atoms or cycloaliphatic diols having 6 to 21 C atoms, e.g. radicals of propane-1,3-diol, 2-ethylpropane-1,3-diol, neopentylglycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethylcyclobutane, 2,2-bis-(4-hydroxyethoxy-phenyl)-propane and 2,2-bis-(4-hydroxypropoxyphenyl)-propane (DE-A 2 407 674, 2 407 776 and 2 715 932).

The polyalkylene terephthalates may be branched by incorporation of relatively small amounts of 3- or 4-hydric alcohols or 3- or 4-basic carboxylic acids, e.g. in accordance with DE-A 1 900 270 and U.S. Pat. No. 3,692,744. Examples of preferred branching agents are trimesic acid, trimellitic acid, trimethylolethane and -propane and pentaerythritol.

Particularly preferred polyalkylene terephthalates are those which have been prepared solely from terephthalic acid and reactive derivatives thereof (e.g. dialkyl esters thereof) and ethylene glycol and/or butane-1,4-diol, and mixtures of these polyalkylene terephthalates.

Mixtures of polyalkylene terephthalates containing 1 to 5.0 wt. %, preferably 1 to 30 wt. % polyethylene terephthalate and 50 to 99 wt. %, preferably 70 to 99 wt. % polybutylene terephthalate are suitable.

The polyalkylene terephthalates that are preferably used have an intrinsic viscosity of 0.4 to 1,5 dl/g, preferably 0.5 to 1.2 dl/g, measured in phenol/o-dichlorobenzene (1:1 parts by weight) at 25° C. in an Ubbelohde viscometer.

The polyalkylene terephthalates may be prepared by known methods (see e.g. Kunststoff Handbuch [Plastics Handbook], volume VIII, p. 695 et seq., Carl-Hanser-Verlag, Munich 1973).

The composition according to the invention may contain component D in an amount of preferably 0 to 80 wt. %, particularly preferably 1 to 60 wt. % and in the most preferred manner 2 to 25 wt. %, based on the weight of the composition.

Component E

The polycarbonate compositions according to the invention may contain conventional additives, such as flameproofing agents, antidripping agents, very finely divided inorganic compounds, lubricants and mold release agents, nucleating agents, antistatics, stabilizers, fillers and reinforcing substances and dyestuffs and pigments.

The compositions according to the invention may in general comprise 0.01 to 20 wt. %, based on the total composition, of flameproofing agents. Examples of flameproofing agents include organic halogen compounds, such as decabromobisphenyl ether and tetrabromobisphenol, inorganic halogen compounds, such as ammonium bromide, nitrogen compounds, such as melamine and melamine-formaldehyde resins, inorganic hydroxide compounds, such as Mg-Al hydroxide, inorganic compounds, such as aluminium oxides, titanium dioxides, antimony oxides, barium metaborate, hydroxoantimonate, zirconium oxide, zirconium hydroxide, molybdenum oxide, ammonium molybdate, tin borate, ammonium borate, barium metaborate and tin oxide, and siloxane compounds.

Phosphorus compounds such as are described in EP-A-363 608, EP-A-345 522 or EP-A-640 655 may furthermore be employed as flameproofing compounds.

The inorganic compounds which may be employed comprise compounds of one or more metals of main group 1 to 5 and of sub-group 1 to 8 of the periodic table, preferably of main group 2 to 5 and of sub-group 4 to 8, particularly preferably of main group 3 to 5 and of sub-group 4 to 8 with the elements oxygen, sulfur, boron, phosphorus, carbon, nitrogen, hydrogen and/or silicon.

Examples of such compounds are oxides, hydroxides, hydrated oxides, sulfates, sulfites, sulfides, carbonates, carbides, nitrates, nitrites, nitrides, borates, silicates, phosphates, hydrides, phosphites or phosphonates. These includes, for example, TiN, TiO₂, SnO₂, WC, ZnO, Al₂O₃, AlO(OH), ZrO₂, Sb₂O₃, SiO₂, iron oxides, NaSO₄, BaSO₄, vanadium oxides, zinc borate and silicates, such as Al silicates, Mg silicates and one-, two- and three-dimensional silicates. Mixtures and doped compounds may also be used. These nanoscale particles may furthermore be modified on the surface with organic molecules in order to achieve a better compatibility with the polymers. Hydrophobic or hydrophilic surfaces may be produced in this manner.

The average particle diameters of the inorganic compounds are smaller than 200 nm, preferably smaller than 150 nm, in particular 1 to 100 nm.

Particle size and particle diameter always me an s the average particle diameter d₅₀, determined by ultracentrifuge measurements by the method of W. Scholtan et al., Kolloid-Z. und Z. Polymere 250 (1972), p. 782 to 796.

The inorganic compounds may be present as powders, pastes, sols, dispersions or suspensions. Powders may be obtained from dispersions, sols or suspensions by precipitation.

The powders may be incorporated into the thermoplastics by conventional processes, for example by direct kneading or extrusion of the constituents of the molding composition and the very finely divided inorganic powders. Preferred processes are the preparation of a masterbatch, e.g. in flameproofing additives, other additives, monomers or solvents, in component A or the coprecipitation of dispersions of components B or C with dispersions, suspension, pastes or sols of the very finely divided inorganic materials.

Possible fillers and reinforcing materials are e.g. glass fibres, optionally cut or ground, glass beads, glass balls, lamellar reinforcing material, such as kaolin, talc, mica, silicates, quartz, talc, titanium dioxide, wollastonite, micaceous material, carbon fibres or mixtures thereof. Cut or ground glass fibres are preferably employed as the reinforcing material. Preferred fillers, which may also have a reinforcing action, are glass beads, mica, silicates, quartz, talc, titanium dioxide and/or wollastonite.

The compositions according to the invention are prepared by mixing the particular constituents in a known manner and subjecting the mixture to melt compounding and melt extrusion at temperatures of 200° C. to 300° C. in conventional units, such as internal kneaders, extruders and twin-screw extruders, the mold release agent being employed in the form of a coagulated mixture.

Mixing of the individual constituents may be carried out in a known manner both successively and simultaneously, and in particular both at about 20° C. (room temperature) and at a higher temperature.

The molding compositions according to the invention may be used for the production of all types of molded bodies. In particular, molded bodies may be produced by injection molding. They are particularly suitable for the production of interior components for motor vehicles, in particular cars and lorries, rail vehicles, ships and buses. Examples of further molded bodies are: housing components of all types, for example for domestic appliances, such as monitors, flat screens, printers and copiers, and cover sheets for the building sector.

Another form of processing is the production of molded bodies by thermoforming from previously produced sheets or films.

Because of their improved adhesion properties, the compositions according to the invention are particularly suitable for the preparation of composite materials with urethanes. Such composite molded bodies are used, for example, as interior components for motor, rail, air and water vehicles, in particular in the fittings sector.

The invention therefore also includes composite materials which comprise at least a first layer (1) and a second layer (2) and wherein layer (1) comprises at least one polycarbonate composition according to the invention and layer (2) comprises at least one polyurethane.

According to a preferred embodiment of the invention, layer (1) is bonded directly to layer (2).

A polyurethane foam or a solid polyurethane layer is preferably employed as layer (2).

The polyurethanes or polyurethane-ureas employed according to the invention are obtained by reaction of polyisocyanates with H-active polyfunctional compounds, preferably polyols.

Possible polyisocyanates are preferably those which are known from polyurethane chemistry and are conventionally employed there. They are, in particular, polyisocyanates on an aromatic basis, e.g. 2,4-diisocyanatotoluene, technical-grade mixtures thereof with 2,6-diisocyanatotoluene, 4,4′-diisocyanatodiphenyl-methane, mixtures thereof with the corresponding 2,4′- and 2,2′-isomers, polyisocyanate mixtures of the diphenylmethane series, such as may be obtained by phosgenation of aniline/formaldehyde condensates in a manner known per se, the modification products of these technical-grade polyisocyanates containing biuret or isocyanate groups, and in particular NCO prepolymers of the type mentioned based on these technical-grade polyisocyanates on the one hand and simple polyols and/or polyether-polyols and/or polyester-polyols on the other hand, and any desired mixtures of such isocyanates, as long as they are sufficiently stable to storage.

Among the higher molecular weight modified polyisocyanates, the prepolymers known from polyurethane chemistry with terminal isocyanate groups and of the molecular weight range of 400 to 10,000, preferably 600 to 8,000, are of interest in particular. These compounds are prepared in a manner known per se by reaction of excess amounts of simple polyisocyanates of the type mentioned by way of example with organic compounds with at least two groups which are reactive towards isocyanate groups, in particular organic polyhydroxy compounds. Suitable such polyhydroxy compounds are both simple polyhydric alcohols of the molecular weight range of 82 to 599, preferably 62 to 200, such as e.g. ethylene glycol, trimethylolpropane, propane-1,2-diol or butane-1,4-diol or butane-2,3-diol, but in particular higher molecular weight polyether-polyols and/or polyester-polyols of the type known per se from polyurethane chemistry with molecular weights of 600 to 8,000, preferably 800 to 4,000, which contain at least two, as a rule 2 to 8, but preferably 2 to 4 primary and/or secondary hydroxyl groups. It is of course also possible to employ those NCO prepolymers which have been obtained, for example, from low molecular weight polyisocyanates of the type mentioned by way of example and less preferred compounds with groups which are reactive towards isocyanate groups, such as e.g. polythioether-polyols, polyacetals containing hydroxyl groups, polyhydroxypolycarbonates, polyester-amides containing hydroxyl groups or copolymers, containing hydroxyl groups, of olefinically unsaturated compounds.

The compounds disclosed in U.S. Pat. No. 4 218 543, for example, are compounds which have groups which are reactive towards isocyanate groups, in particular hydroxyl groups, and are suitable for the preparation of the NCO prepolymers. In the preparation of the NCO prepolymers these compounds with groups which are reactive towards isocyanate groups are reacted with simple polyisocyanates of the type mentioned above by way of example, an NCO excess being maintained. The NCO prepolymers in general have an NCO content of 10 to 25, preferably 15 to 22 wt. %. It already emerges from this that in the context of the present invention “NCO prepolymers” and “prepolymers with terminal isocyanate groups” are to be understood as meaning both the reaction products as such and the mixtures with excess amounts of unreacted starting polyisocyanates, which are often also called “semi-prepolymers”.

The polyisocyanate components has an average functionality of 2 to 3, preferably 2.3 to 2.7.

To establish a particular NCO content of the isocyanate component, it may be appropriate to blend portions of crude MDI with an NCO prepolymer. The portions of material of higher functionality (functionality >4) contained in the crude MDI may be readily tolerated as long as the average functionality of 3 in the isocyanate component is not exceeded.

Possible aliphatic diols with an OH number of >500 mg KOH/g are the chain lengtheners conventionally used in polyurethane chemistry, such as ethylene glycol, diethylene glycol, propylene glycol, dipropylene glycol, butane-1,4-diol and propane-1,3-diol. Diols, such as 2-butane-1,4-diol, butene-1,3-diol, butane-2,3-diol, 2-butane-1,4-diol and/or 2-methylpropane-1,3-diol, are preferred. It is of course also possible to employ the aliphatic diols as a mixture with one another.

Suitable H-active components are polyols with an average OH number of 5 to 500 mg KOH/g and an average functionality of 2 to 4. Polyols with an average OH number of 10 to 50 mg KOH/g and an average functionality of 2.7 to 3 are preferred. Such polyols are, for example, polyhydroxypolyethers, which are known from polyurethane chemistry and are accessible by alkoxylation of suitable starter molecules, such as ethylene glycol, diethylene glycol, 1,4-dihydroxybutane, 1,6-dihydroxyhexane, dimethylolpropane, glycerol, pentaerythritol, sorbitol or sucrose. Ammonia or amines, such as ethylenediamine, hexamethylenediamine, 2,4-diaminotoluene and aniline, or amino-alcohols or phenols, such as bisphenol A, may also function as starter substances. The alkoxylation is carried out using propylene oxide and/or ethylene oxide in any desired sequence.

Polyester-polyols such as are accessible in a manner known per se by reaction of low molecular weight alcohols with polybasic carboxylic acids, such as adipic acid, phthalic acid, hexahydrophthalic acid, tetrahydrophthalic acid or the anhydrides of these acids, are furthermore suitable as long as the viscosity of the H-active component does not become to high. A preferred polyol which contains ester groups is castor oil. Formulations with castor oil, such as may be obtained by dissolving resins, e.g. aldehyde-ketone resins, and modifications of castor oil and polyols based on other naturally occurring oils are additionally also suitable.

Those higher molecular weight polyhydroxypolyethers in which high molecular weight polyadducts or polycondensates or polymers are present in finely disperse, dissolved or grafted-on form are also suitable. Such modified polyhydroxy compounds are obtained in a manner known per se e.g. if polyaddition reactions (e.g. reactions between polyisocyanates and amino-functional compounds) or polycondensation reactions (eg. between formaldehyde and phenols and/or amines) are allowed to proceed in situ in the compounds containing hydroxyl groups. However, it is also possible to mix a finished aqueous polymer dispersion with a polyhydroxy compound and then to remove the water from the mixture.

Polyhydroxy compounds modified by vinyl polymers, such as are obtained e.g. by polymerization of styrene and acrylonitrile in the presence of polyethers or polycarbonate-polyols, are also suitable for the preparation of polyurethanes. If polyether-polyols which have been modified in accordance with DE-A 2 442 101, DE-A 2 844 922 and DE-A 2 646 141 by grafting polymerization with vinylphosphonic acid esters and optionally (meth)acrylonitrile, (meth)acrylamide or OH-functional (meth)acrylic acid esters are used, plastics of particular flame resistance are obtained.

Representatives of the compounds mentioned which are to be used as H-active compounds are described e.g. in High Polymers, vol. XVI, “Polyurethanes Chemistry and Technology”, Saunders-Frisch (ed.) Interscience Publishers, New York, London, vol. 1, p. 32-42, 44, 54 and vol. 11, 1984, p. 5-6 and p. 198-199 incorporated herein by reference.

Mixtures of the compounds listed may also be employed.

The limitation of the average OH number and average functionality of the H-active component results in particular from the increasing embrittlement of the resulting polyurethane. However, the possibilities of influencing the polymer-physical properties of the polyurethane are known in principle to the expert, so that the NCO component, aliphatic diol and polyol may be coordinated to one another in a favourable manner.

The polyurethane layer (2) may be present as a foam or in the massive state, such as e.g. as a lacquer or coating.

All the auxiliary substances and additives, such as e.g. release agents, blowing agents, fillers, catalysts and flameproofing agents, may be employed for the preparation thereof.

Auxiliary substances and additives which are optionally to be used here are:

a) Water and/or readily volatile inorganic or organic substances as blowing agents. Possible organic blowing agents are e.g. acetone, ethyl acetate, halogen-substituted alkanes, such as methylene chloride, chloroform, ethylidene chloride, vinylidene chloride, monofluorotrichloromethane, chlorodifluoromethane and dichlorodifluoromethane, and furthermore butane, hexane, heptane or diethyl ether, and possible inorganic blowing agents are air, CO₂ or N₂O. A blowing action may also be achieved by addition of compounds which dissociate at temperatures above room temperature with splitting off of gases, for example nitrogen, e.g. azo compounds, such as azodicarboxamide or azoisobutyric acid nitrile.

b) Catalysts of the type known per se, e.g. tertiary amines, such as triethylamine, tributylamine, N-methylmorpholine, N-ethylmorpholine, N,N,N′,N′-tetramethylethylenediamine, pentamethyidiethylenetriamine and higher homologues, 1,4-diazabicyclo-(2,2,2)octane, N-methyl-N′-dimethylaminoethylpiperazine, bis-(dimethylaminoalkyl)piperazines, N,N-dimethylbenzylamine, N,N-dimethylcyclohexylamine, N,N-diethylbenzylamine, bis-(N,N-diethylaminoethyl) adipate, N,N,N′,N′,-tetramethyl-1,3-butanediamine, N,N-dimethyl-β-phenylethylamine, 1,2-dimethylimidazole, 2-methylimidazole, monocyclic and bicyclic amides, bis-(dialkylamino)alkyl ethers and tertiary amines containing amide groups (preferably formamide groups). Possible catalysts are also Mannich bases, which are known per se, from secondary amines, such as dimethylamine, and aldehydes, preferably formaldehyde, or ketones, such as acetone, methyl ethyl ketone or cyclohexanone, and phenols, such as phenol, nonylphenol or bisphenol.

Tertiary amines, as the catalyst, which contain hydrogen atoms which are active towards isocyanate groups are e.g. triethanolamine, triisopropanolamine, N-methyidiethanolamine, N-ethyldiethanolamine, N,N-dimethylethanolamine, reaction products thereof with alkylene oxides, such as propylene oxide and/or ethylene oxide, and secondary-tertiary amines.

Possible catalysts are furthermore silaamines, which are know per se, with carbon-silicon bonds, e.g. 2,2,4-trimethyl-2-silamorpholine and 1,3-diethylaminomethyltetramethyldisiloxane.

Possible catalysts are also nitrogen-containing bases, such as tetraalkylammonium hydroxides, and furthermore alkali metal hydroxides, such as sodium hydroxide, alkali metal phenolates, such as sodium phenolate, or alkali metal alcoholates, such as sodium methylate. Hexahydrotriazines may also be employed as catalysts.

The reaction between NCO groups and Zerewitinoff-active hydrogen atoms is also greatly accelerated in a manner known per se by lactams and azalactams, an associate first being formed between the lactam and the compound with acidic hydrogen.

Organometallic compounds, in particular organotin compounds, may also be used as catalysts. Possible organotin compounds, in addition to sulfur-containing compounds, such as di-n-octyl-tin mercaptide, are preferably tin(II) salts of carboxylic acids, such as tin(II) acetate, tin(II) octoate, tin(II) ethylhexoate and tin(II) laurate, and the tin(IV) compounds, e.g. dibutyltin oxide, dibutyltin dichloride, dibutyltin diacetate, dibutyltin dilaurate, dibutyltin maleate or dioctyltin diacetate.

All the above mentioned catalysts may of course be employed as mixtures. Combinations of organometallic compounds and amidines, aminopyridines or hydrazinopyridines are of particular interest here.

The catalysts are as a rule employed in an amount of about 0.001 and 10 wt. %, based on the total amount of compounds with at least two hydrogen atoms which are reactive towards isocyanates.

c) Surface-active additives, such as emulsifiers and foam stabilizers. Possible emulsifiers are e.g. the sodium salts of castor oil-sulfonates or salts of fatty acids with amines, such as oleic acid diethylamine or stearic acid diethanolamine. Alkali metal or ammonium salts of sulfonic acids, such as, for example, of dodecylbenzenesulfonic acid or dinaphthylmethanedisulfonic acid, or of fatty acids, such as ricinoleic acid, or of polymeric fatty acids may also be co-used as surface-active additives.

Suitable foam stabilizers preferably include polyether-siloxanes, especially water-soluble representatives. These compounds are in general built up such that a copolymer of ethylene oxide and propylene oxide is bonded to a polydimethylsiloxane radical.

Polysiloxane/polyoxyalkylene copolymers branched via allophanate groups are often of particular interest.

d) Reaction retardants, e.g. substances which have an acid reaction, such as hydrochloric acid or organic acid halides, and furthermore cell regulators of the type known per se, such as paraffins or fatty alcohols or dimethylpolysiloxanes, and pigments or dyestuffs and flameproofing agents of the type known per se, e.g. tris-chloroethyl phosphate, tricresyl phosphate or ammonium phosphate and polyphosphate, and further stabilizers against ageing and weathering influences, plasticizers and fungistatically and bacteriostatically active substances, as well as fillers, such as barium sulfates, kieselguhr, carbon black or prepared chalk. Further examples of surface-active additives and foam stabilizers as well as cell regulators, reaction retardants, stabilizers, flame-retardant substances, plasticizers, dyestuffs and fillers and fungistatically and bacteriostatically active substances optionally to be co-used according to the invention are known to the expert and described in the literature.

According to a further preferred embodiment of the invention, the composite material according to the invention comprises at least another further polymeric layer (3), in particular a layer based on polyvinyl chloride (PVC) or a thermoplastic urethane (TPU). Layer (3) is preferably bonded directly to layer (2).

The composite material according to the invention is distinguished in particular by an outstanding foam adhesion between layer (1) and layer (2), determined according to the double alternating climate test ACT. The decrease in foam adhesion between layer (1) and layer (2) here after the double alternating climate test is not more than 35%.

The composites may be prepared in a known manner. Preferably, layer (1) is prefabricated from the polycarbonate composition according to the invention and the polyurethane reaction system is applied thereto and reacted. Depending on the reactivity of the polyurethane reaction components, these may already be premixed, or they may be mixed in a known manner during the application. The application is preferably carried out by spraying, knife-coating or calendering. However, it is also possible to prepare the composites according to the invention by coextrusion by known methods. In this case the particulate material is preferably introduced into one of the polyurethane reaction components before the system is applied.

In particular, the polyurethane reaction components are reacted by the one-stage process, which is known per se, the prepolymer process or the semi-prepolymer process. Details regarding processing equipment are described in Kunststoff-Handbuch [Plastics Handbook], volume VII, published by Vieweg and Höchtlen, Carl-Hanser-Verlag, Munich 1966, e.g. on pages 121 to 205.

In the PU foam production, according to the invention the foaming may also be carried out in closed molds. In this case the reaction mixture is introduced into a mold already containing layer (1). Metal, e.g. aluminium, or plastic, e.g. epoxy resin, is possible as the mold material.

The foamable reaction mixture foams in the mold and forms the composite molded body. The foaming in the mold may be carried out here such that the molding has a cell structure on its surface, but it may also be carried out such that the molding has a solid skin and a cellular core. In this connection, a procedure may be followed here in which foamable reaction mixture is introduced into the mold in an amount such that the foam formed just fills the mold. However, a procedure may also be followed in which more foamable reaction mixture than is necessary to fill the inside of the mold with foam is introduced into the mold. In the last case the “over-charging” procedure is thus followed in a manner known per se.

“External release agents” which are known per se, such as silicone oils, are often also used for foaming in the mold. However, it is also possible to use so-called “internal release agents”, optionally as a mixture with external release agents.

Cold-curing foams may also be prepared according to the invention.

However, foams may of course also be prepared by block foaming or by the double conveyor belt process, which is known per se and is preferred for continuous preparation of the composites according to the invention.

In these procedures also, the particulate material is distributed in one component before the PU components are reacted.

The production of polyurethane composite bodies in sandwich construction is also preferred. The process may be equipped here as either a depot or shell construction process. Both depot construction and shell construction are known per se. In the depot process (filling construction), two half-shells (e.g. top layers of plastics) are prefabricated and laid in a mold and the hollow space between the shells is foam-filled with the PU foam. In shell construction a core of PU foam is initially introduced into a mold and then enclosed by a suitable shell material, e.g. with one of the thermoplastics mentioned. Shell construction is preferred for the production of sandwich composite bodies.

For the preparation of solid PU materials, the two PU reaction components, as described above, are reacted by simple mixing at room temperature.

Subsequent further coating of layers (1) or (2) may be carried out by the conventional known processes of lacquering, metallization or further coating with a polymeric layer.

The composite materials according to the invention are preferably used in car production, in particular in lining interiors, e.g. as a coating material for dashboards or pillar linings.

The invention is explained in more detail in the following with the aid of embodiment examples.

### EXAMPLES

Four polycarbonate compositions are prepared according to the information in table 1, further processed to test specimens and tested.

Component A

Linear polycarbonate based on bisphenol A with a relative solution viscosity of 1.272, measured in CH₂Cl₂ as the solvent at 25° C. and at a concentration of 0.5 g/100 ml.

Component B

Graft polymer of 40 parts by wt. of a copolymer of styrene and acrylonitrile in a ratio of 72:28 on 60 parts by wt. of particulate crosslinked polybutadiene rubber (average particle diameter d₅₀=0.32 μm), prepared by emulsion polymerization.

Component C

Random copolymer of 82 wt. % styrene and 18 wt. % maleic anhydride with an average molecular weight M_{w} of 100,000 (Cadon® DMC catalyst 250, Bayer AG, Leverkusen, Germany).

TABLE 1

Composition

| Components (parts by wt.) | 1 | 2 | 3 | 4 (comp). |
|---|---|---|---|---|
| A (Polycarbonate) | 58 | 58 | 58 | 58 |
| B (Graft polymer) | 42 | 42 | 42 | 42 |
| C (Styrene/maleic anhydride) | 2 | 0.5 | 5 | 0 |

Preparation and testing of the composite materials according to the invention

Mixing of the components of the polycarbonate compositions is carried out on a 3 1 internal kneader. Specimens of the polycarbonate compositions are produced on an injection molding machine of the Arburg 270 E type at 260° C.

The notched impact strength ak of the polycarbonate specimens is determined in accordance with ISO 180/1 A.

The Vicat B heat distortion point of the polycarbonate specimens is determined in accordance with DIN 53 460 (ISO 306) on bars of dimensions 80×10×4 mm³.

The critical temperature and the modulus of the polycarbonate specimens are determined in accordance with ISO 180/1 A and ISO 527.

To measure the foam adhesion, the polycarbonate specimens are covered with a thin 1 cm layer of 100 parts by wt. of polyurethane Bayfill® VP PU51 IF03 and 44 parts by wt. Desmodur® VP 44 V20LF (Bayer AG, Leverkusen, Germany) and the separation of the composite was tested by a conventional roller peeling test in accordance with DIN 53 357. Before the adhesion test the laminar composite is subjected to a double alternating climate test (ACT 02A) (10 days exposure in an alternating climate with cycles of −40° C. to 80° C., 0 to 80% relative atmospheric humidity and a cycle time of 24 hours). The subsequent adhesion test is carried out by a 90° peeling test in accordance with DIN 53 357 after reduction of the foam thickness to 2 mm.

The test results of compositions 1 to 4 are summarized in table 2.

TABLE 2

Composition

| Properties | | 1 | 2 | 3 | 4 (comp.) |
|---|---|---|---|---|---|
| aₖ Izod | 23° C. [kJ/m²] | 67 | 63 | 74 | 62 |
| (260° C.) | −40° C. [kJ/m²] | 76 | 66 | 81 | 64 |
| Critical | [°0 C.] | −45 | −45 | −45 | −45 |
| temperature | | | | | |
| Vicat B | [°0 C.] | 117 | 119 | 121 | 120 |
| Modulus | [MPa] | 2,150 | 2,140 | 2,210 | 2,130 |
| Foam adhesion | | | | | |
| after double | [%] | −2 | −30 | −31 | −38 |
| ACT (02A) | | | | | |

The test results show that compositions 1 to 3 according to the invention, which comprise a styrene/maleic anhydride copolymer, have improved foam adhesion values compared with comparison specimen 4, which comprises no styrene/maleic anhydride copolymer. Composition 1 according to the invention with a content of styrene/maleic anhydride copolymer of 1.9 wt. % (=2.0 parts by wt., based on 100 parts by wt. of components A+B) has a particularly good foam adhesion with a deterioration in adhesion of only 2% in the double alternating climate test.

The test results furthermore show that specimens 1 to 3 according to the invention show, in addition to the increased foam adhesion, a constantly good notched impact strength ak and Vicat B heat distortion point.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A polycarbonate composition comprising
(A) an aromatic polycarbonate and/or polyester-carbonate
(B) a graft polymer and
(C) a copolymer of styrene and at least one monomer containing at least one carboxyl group, the copolymer having a weight average molecular weight, M_{w}, equal to or greater than 10,500 g/mol.

2. The composition according to claim 1, wherein (C) is present in an amount of 0.4 to 7% relative to the weight of the composition.

3. The composition according to claim 1 wherein (C) is present in an amount of 1 to 4% relative to the weight of the composition.

4. The composition according to claim 1 wherein (C) is a copolymer of styrene and maleic anhydride.

5. The composition according to claim 4, wherein (C) contains maleic anhydride in an amount of 1 to 40% relative to the weight of (C).

6. The composition according to claim 1 wherein the weight average molecular weight of (C) is 10,500 to 300,000.

7. The composition according to claim 1 wherein (A) is present in an amount of 5 to 98% relative to the weight of the composition.

8. The composition according to claim 1 wherein (A) is present in an amount of 4 to 75% relative to the weight of the composition.

9. The composition according to claim 1 wherein (B) is a graft of B.1) 5 to 95 wt. % of one or more vinyl monomers on B.2) 95 to 5 wt. % of one or more graft bases having glass transition temperatures lower than 10° C.

10. The composition according to claim 1 wherein (B) is present in an amount of 1 to 94% relative to the weight of the composition.

11. The composition according to claim 1 wherein (B) is present in an amount of 5 to 60% relative to the weight of the composition.

12. The composition according to claim 1 further containing (D) at least one thermoplastic vinyl (co)polymer and/or polyalkylene terephthalate.

13. The composition according to claim 12 wherein D is present in an amount of 0 to 25% relative to the weight of the composition.

14. The composition according to claim 1 further containing (E) at least one additive selected from the group consisting of flameproofing agents, fluorinated polyolefins and inorganic particles.

15. The composition of claim 14 wherein inorganic particles are selected from the group consisting of talc, mica, wollastonite, quartz, and titanium dioxide.

16. A process for the preparation of the composition of claim 1 comprising mixing (A), (B) and (C) and subjecting the resulting mixture to melt compounding and melt extrusion at temperatures of 200 to 300° C. in conventional units.

17. A method of using the composition of claim 1 comprising producing a molded article.

18. The molded article prepared by the method of claim 17.

19. A multi-layered composite comprising at least one first layer that includes the composition of claim 1 and a second layer that contains polyurethane.

20. The composite of claim 19, wherein said first layer is bonded directly to said second layer.

21. The composite of claim 20 wherein said second layer is a polyurethane foam.

22. The composite of claim 20 wherein said second layer is a solid polyurethane.

23. The composite of claim 20 further comprising at least one additional polymeric layer.

24. The composite of claim 23, wherein the additional polymeric layer contains polyvinyl chloride.

25. The composite of claim 23 wherein the additional layer is bonded directly to the second layer.
